(19) United States
(12) Patent Application Publication
(10) Pub. No.: US 2011/0279738 A1
(43) Pub. Date: Nov. 17, 2011

(54) CONTROL DEVICE AND PROJECTION VIDEO DISPLAY DEVICE

(75) Inventors: Tatsuya TAKAHASHI, Moriguchi City (JP); Toshio Nakakuki, Moriguchi City (JP)

(73) Assignee: SANYO Electric Co., Ltd., Moriguchi City (JP)

(21) Appl. No.: 13/105,144

(22) Filed: May 11, 2011

(30) Foreign Application Priority Data
May 14, 2010 (JP) 2010-112276

(51) Int. Cl. H04N 9/31

(52) U.S. Cl. 348/744; 348/E09.025

(57) ABSTRACT

A projection video display device is provided with a projection unit configured to project a video onto a screen via a lens; and an image pickup unit configured to image the screen. A brightness component selection unit receives an image imaged by the image pickup unit when reference light is projected onto the screen and select, of brightness components of pixels forming the image, a brightness component having the maximum value. An exposure correction unit originates a signal for adjusting exposure time in an image pickup device in the image pickup unit with reference to the selected brightness component. A color correction unit receives an image captured by the image pickup unit after the adjustment and corrects the video so that the brightness components are in equal proportion.

### CROSS-REFERENCE TO RELATED APPLICATIONS

This application is based upon and claims the benefit of priority from the prior Japanese Patent Application No. 2010-112276, filed on May 14, 2010, the entire contents of which are incorporated herein by reference.

### BACKGROUND OF THE INVENTION

1. Field of the Invention

The present invention relates to an exposure correction technology adapted for a projection video display device for projecting an image onto a screen.

2. Description of the Related Art

Recently, video display devices of projection type provided with a camera (hereinafter, referred to as projector as appropriate) are in practical use. Some projectors provided with a camera are provided with an image setting function for image a projected test pattern using the camera and perform autofocusing based on the captured image.

Projection devices are known that comprise a camera for imaging a focus pattern projected onto a screen, a focus area setting unit for setting a focus area in the image captured by the camera, and an autofocus control unit for automatically performing focus adjustment of the projection lens, while analyzing the focus area of the captured mage. According to the related-art approach, autofocus control is performed only in an area onto which the focus pattern is projected regardless of the zooming position of the projection lens of the projector. For this reason, high-precision autofocusing is possible even when intense disturbance lights are present in the neighborhood of the screen.

An ordinary projection video display device is configured to display an image in accurate color tone when a color video signal comprising input R, G, and B signals is projected onto a white screen. Therefore, the video may be reproduced in improper colors when the screen is not white or when the screen is affected by disturbance lights.

### SUMMARY OF THE INVENTION

The present invention addresses the above-mentioned issue and a purpose thereof is to provide a technology of correcting exposure with video light in such a way that effects from the screen color or disturbance lights are mitigated and the video is reproduced on the screen in the color as true to the original as possible.

The control device addressing the above issue is provided in a projection video display device having a projection unit for projecting a video onto a screen via a lens, and an image pickup unit for imaging the screen. The control device comprises: a brightness component selection unit configured to receive an image imaged by the image pickup unit when reference light is projected onto the screen and select, of brightness components of pixels forming the image, a brightness component having the maximum value; an exposure correction unit configured to originate a signal for adjusting exposure time in an image pickup device in the image pickup unit with reference to the selected brightness component; and a color correction unit configured to receive an image captured by the image pickup unit after the adjustment and correct the video so that the brightness components are in equal proportion.

Another embodiment of the present invention relates to a control device provided in a projection video display device having a projection unit for projecting a video onto a screen via a lens, and an image pickup unit for imaging the screen, the control device comprising: a brightness component selection unit configured to receive an image imaged by the image pickup unit when reference light is projected onto the screen and select, of brightness components of pixels forming the image, a brightness component having the maximum value; and an exposure correction unit configured to correct the reference light so that the brightness components are in equal proportion with reference to the selected brightness component.

Another embodiment of the present invention relates to a projection video display device.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows relative positions of a video display device of projection type according to the embodiment and a screen;

FIG. 2 shows the configuration of the projection video display device according to the first embodiment;

FIG. 3 is a flowchart showing the exposure correction process according to the first embodiment;

FIG. 4 shows the configuration of the projection video display device according to the second embodiment; and

FIG. 5 is a flowchart of the exposure correction process according to the second embodiment.

### DETAILED DESCRIPTION OF THE INVENTION

The invention will now be described by reference to the preferred embodiments. This does not intend to limit the scope of the present invention, but to exemplify the invention.

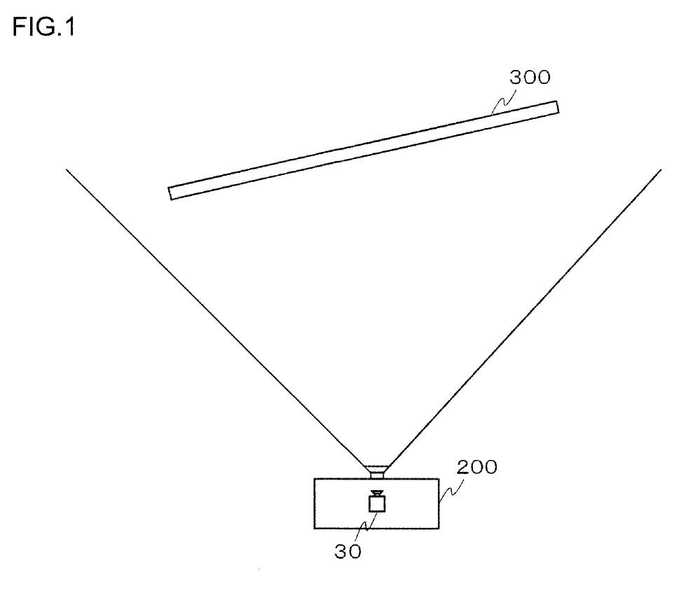

FIG. 1 shows relative positions of a video display device 200 of projection type according to the first embodiment and a screen 300. The projection video display device 200 according to the embodiment is provided with an image pickup unit 30 configured to capture an image in the direction of the screen 300. The image pickup unit 30 is provided such that the light axis of the unit 30 is, for example, parallel with the light projected by the projection video display device 200. FIG. 1 shows that the right end of the screen 300 recedes instead of facing directly opposite to the projection video display device 200.

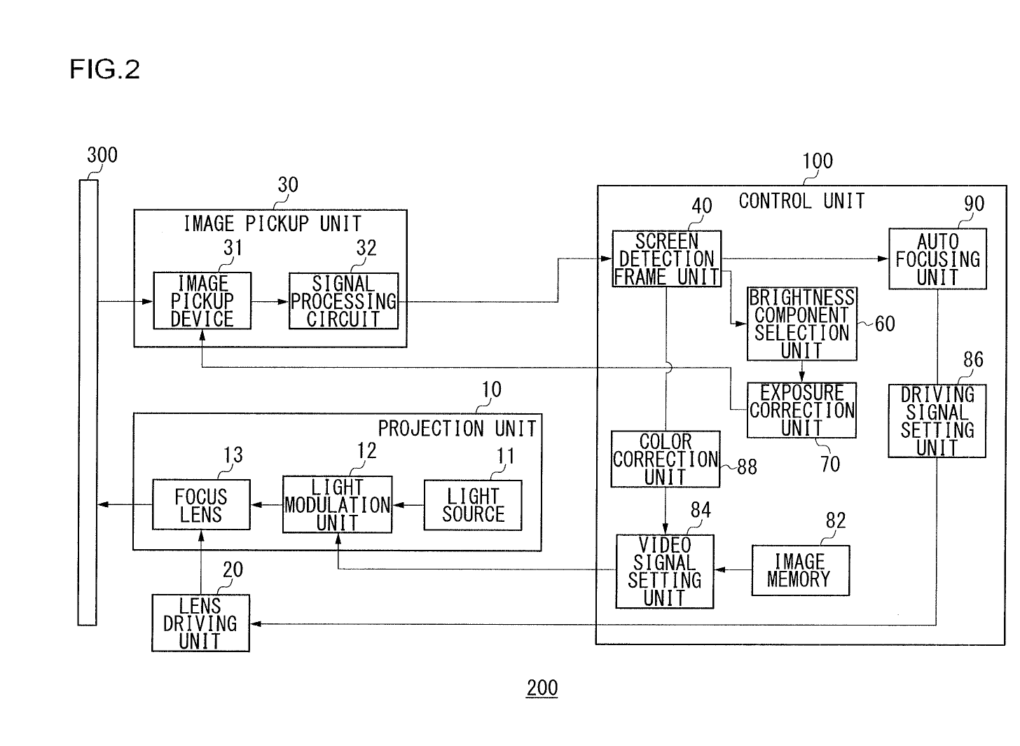

FIG. 2 shows the configuration of the projection video display device 200. The projection video display device 200 is provided with a projection unit 10, a lens driving unit 20, an image pickup unit 30, and a control unit 100. The control unit 100 is provided with a screen frame detection unit 40, a brightness component selection unit 60, a exposure correction unit 70, an image memory 82, a video signal setting unit 84, a driving signal setting unit 86, a color correction part 88, and an auto-focusing unit 90.

The configuration of the control unit 100 is implemented by hardware such as a CPU, memory, or other LSIs of an arbitrary computer and by software such as a program or the like loaded into the memory. FIG. 1 depicts functional blocks implemented by the cooperation of hardware and software. Therefore, it will be obvious to those skilled in the art that the functional blocks may be implemented in a variety of manners by hardware only, software only, or a combination of thereof.

The projection unit 10 projects an image onto the screen 300. The projection unit 10 includes a light source 11, a light modulation unit 12, and a focus lens 13. A halogen lamp having a filament electrode structure, a metal halide lamp having an electrode structure that generates arc discharge, a xenon short arc lamp, a high-pressure mercury lamp, a LED lamp, etc. can be used as the light source 11.

The image memory 82 maintains image data that should be projected onto the screen 300. The image data is supplied from a PC etc. via an external interface, which is not illustrated. According to this embodiment, a special pattern for screen frame detection or a test pattern projected at the time of auto-focusing are also maintained. The video signal setting unit 84 sets a video signal based on the image data maintained in the image memory 82 in the light modulation unit 12. The driving signal setting unit 86 sets a driving signal for moving the focus lens 13 to the lens position designated by the auto-focusing unit 90 in the lens driving unit 20.

The light modulation unit 12 modulates the light incident from the light source 11 according to the video signal set up by the video signal setting unit 84. For example, DMD (Digital Micromirror Device) may be employed as the light modulation unit 12. A DMD is provided with a plurality of micro mirrors corresponding to the number of pixels. Desired image lights are generated by controlling the direction of each micro mirror according to a pixel signal.

The focus lens 13 adjusts the focal position of the light incident from the light modulation unit 12. The lens position of the focus lens 13 is moved by the lens driving unit 20 on an light axis. The image lights generated by the light modulation unit 12 are projected onto the screen 300 via the focus lens 13.

The lens driving unit 20 moves the position of the focus lens 13 according to the driving signal set up by the driving signal setting unit 86. A stepping motor, a voice coil motor (VCM), a piezo-electric element, etc. may be used as the lens driving unit 20.

The image pickup unit 30 images the screen 300 and the image projected onto the screen 300 as primary subjects. The image pickup unit 30 includes a solid state image pickup device 31 and a signal processing circuit 32. A CMOS (Complementary Metal Oxide Semiconductor) image sensor, a CCD (Charge Coupled Devices) image sensor, etc. may be used as the solid state image pickup device 31. The signal processing circuit 32 subjects the signal output from the solid state image pickup device 31 to various signal conditioning such as A/D conversion and conversion from the RGB format to the YUV format and outputs the resultant signal to the control unit 100.

According to this embodiment, it is necessary to detect the frame of the screen onto which the image is projected before running exposure correction. For this purpose, the projection unit 10 projects a special pattern for detection of the screen frame (e.g., an entirely white image) onto the screen 300 when the projection video display device 200 is started or in accordance with a command such as the user's button operation. The image pickup unit 30 images the screen 300 and the specific pattern projected onto the screen 300 and outputs the captured image to the screen frame detection unit 40.

The screen frame detection unit 40 detects the frame of the screen captured in the image picked up by the image pickup unit 30. More specifically, the screen frame detection unit 40 detects the position of the four sides (the upper side, the lower side, left-hand side, and right-hand side) of the screen captured in the image by extracting the edges in the captured image. The detected screen frame is identified by the apex coordinates of the four corners, for example.

The brightness component selection unit 60 receives the image picked up by the image pickup unit 30 when the entirely white (colorless) reference light is projected onto the screen 300. Of the R, G, and B brightness components forming the captured image, the brightness component selection unit 60 selects the brightness component having the maximum value.

The brightness component selection unit 60 may select the brightness component having the maximum value based on the entirety of the captured image. More suitably, the brightness component selection unit 60 selects the brightness component having the maximum value only within the screen frame detected by the screen frame detection unit 40. This can prevent the wall color outside the screen frame or disturbance light from affecting the selection.

The exposure correction unit controls the image pickup device 31 so that none of the R, G, and B brightness components indicates overexposure, i.e., so that the charge stored in individual devices in the image pickup device does not saturate. More specifically, the exposure correction unit 70 adjusts the exposure time of the image pickup device 31 so that the brightness component having the maximum value selected by the brightness component selection unit 60 is less than the maximum permitted value in the image pickup device 31.

The screen frame detection unit 40 receives the image newly picked up by the image pickup unit 30 after the above-mentioned adjustment so as to detect the screen frame. The color correction unit 88 corrects the video signal in the video signal setting unit 84 so that the R, G, and B brightness components are equal in proportion, i.e., so that R:G:B=1:1:1, based on the ratio of the R, G, and B brightness components after exposure control performed by the exposure correction unit 70.

Color correction of the video signal as described above is well known in the art so that further detailed description will be omitted in this specification.

The video signal supplied to the video signal setting unit 84 is subject to other processes such as a scaling process whereby the video is enlarged or reduced in accordance with the size of the screen frame, and a keystone correction process whereby the shape of the video is corrected in accordance with the shape of the projected video as detected (not described in this specification in detail).

The auto-focusing unit 90 brings the image in focus by, for example, using a well-known technique such as the contrast detection method. When the projection video display device 200 is started or when the user requests auto-focusing by a user operation, the video signal setting unit 84 reads a test pattern for auto-focusing from the image memory 82 and causes the projection unit 10 to project the test pattern. The test pattern is formed by a stripe pattern or a checkered flag pattern, for example. The image pickup unit 30 images the test pattern projected onto the screen 300.

The auto-focusing unit 90 determines the position of the lens based on the sharpness of a detection area preset by the screen frame detection unit 40 in a plurality of images picked up by the image pickup unit 30 at a plurality of lens positions, respectively. The configuration of the auto-focusing unit 90 will now be described in specific details.

The auto-focusing unit 90 includes a high pass filter, an integrating unit, and a lens position determination unit (not shown). The high pass filter extracts high frequency components of the image signal in the above-mentioned detection area exceeding a predetermined threshold and supplies the extracted high frequency components to the integration unit. The high pass filter may extract high frequency components horizontally or may extract high frequency components in both horizontal and perpendicular directions.

The integration unit integrates the high frequency components extracted by the high pass filter at each lens position and supplies the extracted components to the lens position determination unit. When high frequency components are extracted by the high pass filter in both horizontal and perpendicular directions, the integration unit sums the high frequency components in both directions. The lens position determination unit refers to the plurality of integrated values supplied from the integration unit and determines the position of the focus lens where the maximum integrated value is detected as the focal position.

When the auto-focusing function is enabled, the auto-focusing unit 90 requests the video signal setting unit 84 to project a test pattern and sets, in the driving signal setting unit 86, a control signal for moving the focus lens 13 in predetermined steps from near the screen and away from the screen or toward the screen. The video signal setting unit 84 sets the video signal of the test pattern in the light modulation unit 12, and the driving signal setting unit 86 sets the driving signal determined by the above-mentioned control signal in the lens driving unit 20.

The auto-focusing unit 90 computes the sharpness (the above-mentioned integrated value can be used) that was picked up in each lens position of the focus lens 13 and that is included in the test pattern. This sharpness rises as the focus lens 13 approaches the focusing position. When the rise hits the peak and begins to drop, the auto-focusing unit 90 determines the immediately preceding lens position as the focal position.

An ordinary projection video display device is configured to display an image in accurate color tone when a color video signal comprising input R, G, and B signals is projected onto a white screen. Therefore, the video may be reproduced in improper colors when the screen is not white.

Further, as shown in FIG. 1, when the screen onto which the video is projected is diagonally placed, the brightness on the screen differs between a position near the image pickup unit and a position far from the image pickup unit. This results in difference in color tone of the video reproduced at the opposite ends of the screen. Further, the video may be displayed in improper color tone when disturbance lights illuminate the screen.

Some related-art projection video display devices are designed to reproduce the original color tone of the video as much as possible by defining special modes such as “blackboard mode” or “red wall mode” and applying certain correction to the video signal when the video is projected onto a blackboard or a red wall. However, such methods can only address colors presumed in advance. The related-art approach cannot address effects from disturbance lights.

Projection of video onto a red wall will be considered by way of example. In this case, R components are predominant in the reflected light received by the image pickup unit 30 and G components and B components are in less amounts. When ordinary exposure is exercised in this state, the R components easily saturate.

Unlike exposure control in ordinary cameras, the color of the screen onto which the video is projected should be accurately identified in this embodiment. In this embodiment, the exposure time of the image pickup unit is adjusted based on the largest of the R, G, and B brightness components and the color of the video signal is corrected subsequently, as described above.

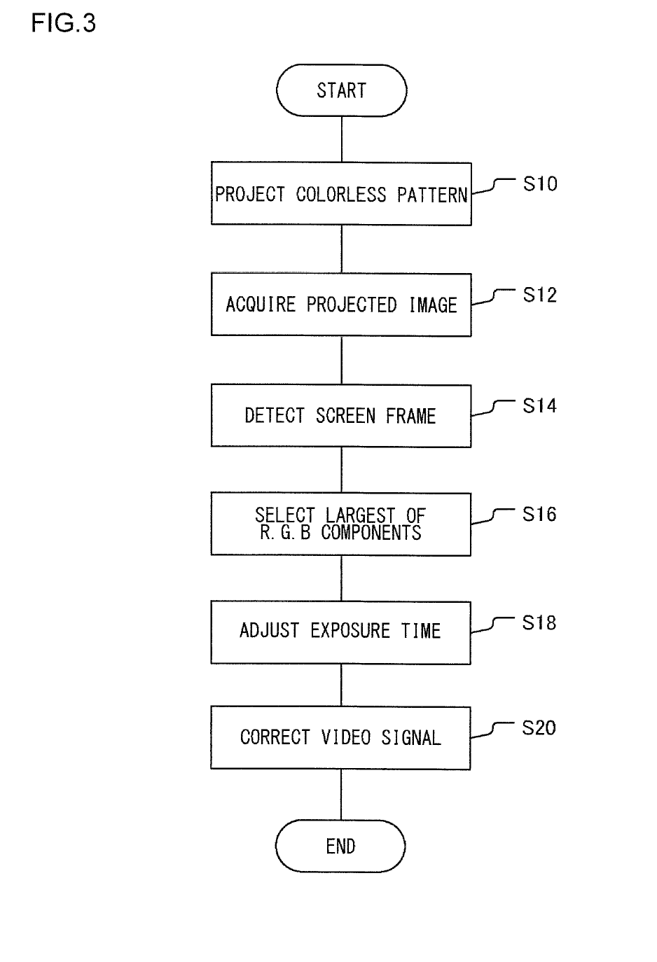

FIG. 3 is a flowchart showing the exposure correction process according to the first embodiment. First, the projection unit 10 projects an entirely white (colorless) image onto the screen 300 for display (S10). The image pickup unit 30 images the screen 300 and the image projected onto the screen 300 and outputs the captured image to the screen frame detection unit 40 (S12). The screen frame detection unit 40 detects the screen frame from the captured image (S14). Of the brightness components forming the image, the brightness component selection unit 60 selects the brightness component having the maximum value within the detected screen frame (S16). The exposure correction unit 70 adjusts the exposure time of the image pickup device 31 so that the brightness component having the maximum value selected by the brightness component selection unit 60 is less than the maximum permitted value in the image pickup device 31 (S18). The color correction unit 88 corrects the video signal in the video signal setting unit 84, based on the ratio of the R, G, and B brightness components after exposure control performed by the exposure correction unit 70.

As described above, colorless reference light is projected onto the screen and the screen is imaged by a camera. The exposure time of the image pickup device is adjusted based on the largest of the R, G, and B brightness components in the captured image.

By adjusting the exposure time of the image pickup unit as described above, the color of the screen is accurately identified and the video signal is corrected based on the identified color, even when the color of the projection plane of the screen is other than white. For this reason, the color shade true to the color tone defined in the video signal with reference to a white screen is reproduced on the screen.

A description will now be given of the second embodiment of the present invention. In the second embodiment, colorless reference light is projected onto the screen and the screen is imaged by a camera. Exposure with the reference light is corrected based on the largest of the R, G, and B brightness components in the captured image.

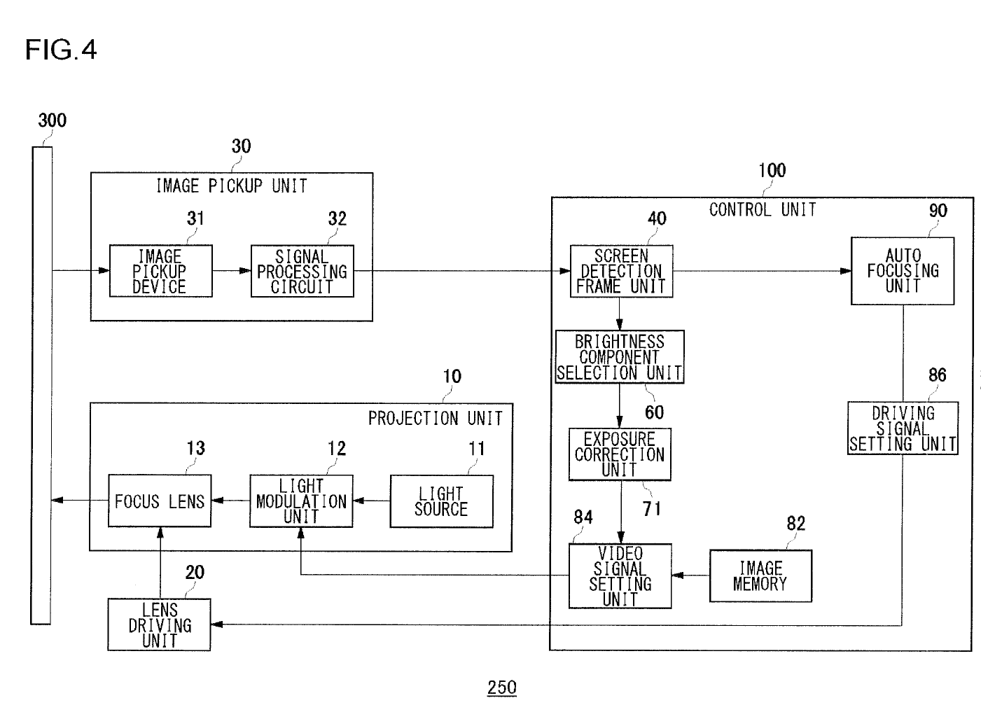

FIG. 4 shows the configuration of the projection video display device 250 according to the second embodiment. Blocks denoted by the same reference numerals as those of FIG. 2 have the identical functions except that the function of the exposure correction unit 71 differs from that of the exposure correction unit 70.

The exposure correction unit 71 corrects the reference light so that the R, G, and B brightness components are equal in proportion, i.e., so that R:G:B=1:1:1 with reference to the brightness component selected by the brightness component selection unit 60. By correcting the reference light in this way, none of the brightness components saturates in the image captured by the image pickup unit 30. Since determination is not made based on the entirety of the brightness values, the range covered by the signal values can be efficiently used.

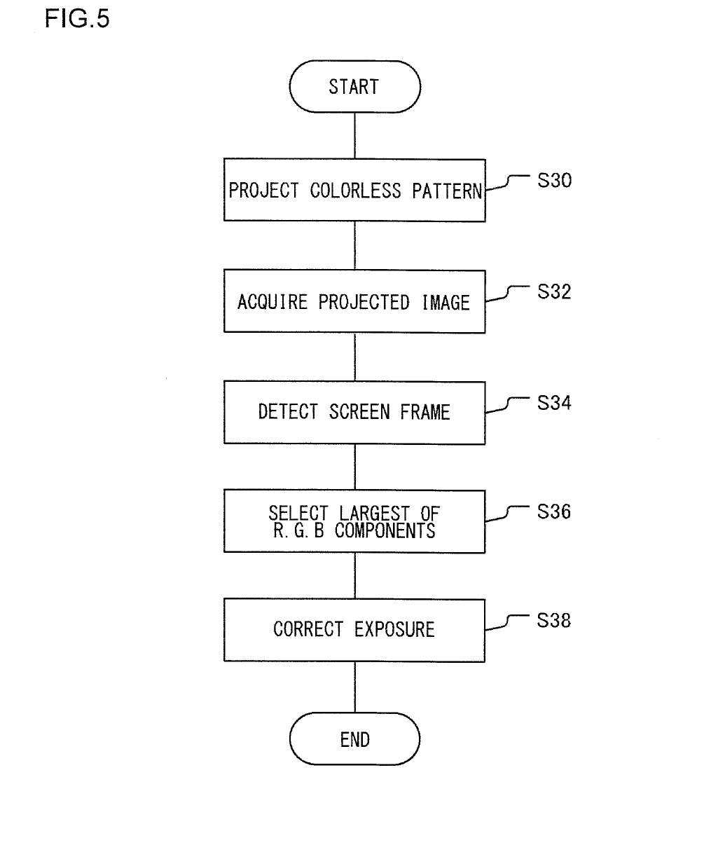

FIG. 5 is a flowchart of the exposure correction process according to the second embodiment. First, the projection unit 10 projects an entirety white (colorless) image onto the screen 300 for display (S30). The image pickup unit 30 images the screen 300 and the image projected onto the screen 300 and outputs the captured image to the screen frame detection unit 40 (S32). The screen frame detection unit 40 detects the screen frame from the captured image (S34). Of the brightness components forming the image, the brightness component selection unit 60 selects the brightness component having the maximum value within the detected screen frame (S36). The exposure correction unit 70 adjusts the reference light so that the brightness components are equal in proportion with reference to the brightness component selected by the brightness component selection unit 60 (S38).

As described above, the second embodiment is configured such that colorless reference light is projected onto the screen and the screen is imaged by a camera. The exposure with the reference light is corrected based on the largest of the R, G, and B brightness components in the captured image.

By correcting exposure with the reference light as described above, the color shade true to the color tone defined in the video signal with reference to a white screen is reproduced on the screen when the color of the projection plane of the screen is other than white.

In this embodiment, the reference light is corrected so that the R, G, and B brightness components are equal in proportion with reference to the brightness component having the maximum value. By correcting the reference light in this way, none of the brightness components saturates in the image captured by the image pickup unit 30. Further, the range covered by the signal values can be efficiently used. Since exposure control is exercised based only on the monotone, time required for exposure control is reduced.

The description given above assumes that the projection video display device projects a video onto a dedicated screen 300. However, a video is often projected onto a mere wall surface without using a screen. In this case, the screen frame detection unit may not be able to detect the screen frame or detect the periphery of the video projected onto the wall surface as the screen frame in error. When the frame of the screen is not detected, the brightness component selection unit 60 may select the brightness component having the maximum value by referring to the entirety of the image or determine to suspend the correction of the reference light.

Described above is an explanation based on an exemplary embodiment. The embodiment is intended to be illustrative only and it will be obvious to those skilled in the art that various modifications to constituting elements and processes could be developed and that such modifications are also within the scope of the present invention.

What is claimed is:

1. A control device provided in a projection video display device having a projection unit for projecting a video onto a screen via a lens, and an image pickup unit for imaging the screen, the control device comprising:
a brightness component selection unit configured to receive an image imaged by the image pickup unit when reference light is projected onto the screen and select, of brightness components of pixels forming the image, a brightness component having the maximum value;
an exposure correction unit configured to originate a signal for adjusting exposure time in an image pickup device in the image pickup unit with reference to the selected brightness component; and
a color correction unit configured to receive an image captured by the image pickup unit after the adjustment and correct the video so that the brightness components are in equal proportion.

2. The control device according to claim 1, further comprising:
a screen frame detection unit configured to detect a screen frame from the image captured by the image pickup unit,
wherein the brightness component selection unit selects the brightness component having the maximum value only within the detected screen frame.

3. A projection video display device comprising:
a projection unit configured to project a video onto a screen via a lens;
an image pickup unit configured to image the screen; and
the control device according to claim 1.

4. A control device provided in a projection video display device having a projection unit for projecting a video onto a screen via a lens, and an image pickup unit for imaging the screen, the control device comprising:
a brightness component selection unit configured to receive an image imaged by the image pickup unit when reference light is projected onto the screen and select, of brightness components of pixels forming the image, a brightness component having the maximum value; and
an exposure correction unit configured to correct the reference light so that the brightness components are in equal proportion with reference to the selected brightness component.

5. The control device according to claim 4, further comprising:
a screen frame detection unit configured to detect a screen frame from the image captured by the image pickup unit,
wherein the brightness component selection unit selects the brightness component having the maximum value only within the detected screen frame.

6. A projection video display device comprising:
a projection unit configured to project a video onto a screen via a lens;
an image pickup unit configured to image the screen; and
the control device according to claim 4.
